(19) United States
(12) Patent Application Publication
(10) Pub. No.: US 2011/0261756 A1
(43) Pub. Date: Oct. 27, 2011

(54) METHOD FOR REPORTING INFORMATION ABOUT RESULT OF Iu-UP PROTOCOL NEGOTIATION, PROTOCOL CONVERSION METHOD, COMMUNICATION NETWORK SYSTEM, INTERWORKING DEVICE, DEVICE FOR ACQUIRING INFORMATION ABOUT RESULT OF IuUP NEGOTIATION, AND COMPUTER-READABLE INFORMATION RECORDING MEDIUM

(76) Inventor: Kensuke Matsushima, Tokyo (JP)

(21) Appl. No.: 12/999,995

(22) PCT Filed: Jul. 16, 2009
(86) PCT No.: PCT/JP2009/062883

§ 371 Date: Dec. 17, 2010

(30) Foreign Application Priority Data
Jul. 16, 2008 (JP) 2008-184870

(51) Int. Cl. H04W 4/00

(52) U.S. Cl. 370/328

(57) ABSTRACT

A communication network system in which a CS (Circuit Switched) terminal is connected to an IMS (IP Multimedia Subsystem) via an RNC (radio network controller) and the Iu-UP (Iu-User Plane) is terminated by the RNC comprises: an IuUP negotiation result information acquiring device which requests the RNC to supply IuUP negotiation result information and receives the IuUP negotiation result information from the RNC; and an interworking device which receives the IuUP negotiation result information from the IuUP negotiation result information acquiring device and executes protocol conversion between an IuUP protocol and a protocol used in the IMS by use of the IuUP negotiation result information when a connection is made between the CS terminal and the IMS.

### TECHNICAL FIELD

The present invention relates to a method of reporting (noticing) Iu-UP protocol negotiation result information (Iu-UP protocol negotiation result information reporting method), a communication network system and a computer-readable information recording medium.

### BACKGROUND ART

The IMS (IP Multimedia Subsystem) is a subsystem for providing 3G (third-generation) cellular phones and wireless LANs with IP-based multimedia services independently of the access network. The IMS enables not only the provision of IP-based services but also provision of services by making a connection to a PSTN (Public Switched Telephone Network).

The IMS is independent of the CS domain since it is a subsystem constructed on the PS domain. Thus, in order to provide 3G CS terminals with IMS services without affecting existing systems, it is necessary to carry out bearer protocol conversion from the Iu-UP protocol used in the CS domain into a bearer protocol used in the IMS.

A technique disclosed in Patent Literature 1 (see below) can be taken as an example of technology relating to the Iu-UP protocol. By employing the technique described in Patent Literature 1, a switch on the radio network's side is enabled to make a check of the Iu-UP protocol and execute data processing.

### CITATION LIST

### Patent Literature

{PTL 1} JP-A-2003-101578

### SUMMARY OF INVENTION

### Technical Problem

The exemplary object of the present invention is to provide an Iu-UP protocol negotiation result information reporting method, a protocol conversion method, a communication network system, an interworking device, an IuUP negotiation result information acquiring device and a computer-readable information recording medium by which reporting of the IuUP negotiation result held by an RNC to an IWF device can be implemented and MRF connection for a sound source connection (e.g., RBT (Ring Back Tone)) can be realized in a system in which the Iu-UP (Iu-User Plane) is terminated by the RNC.

### Solution to Problem

According to an exemplary first aspect of the present invention, there is provided a communication network system in which a CS (Circuit Switched) terminal is connected to an IMS (IP Multimedia Subsystem) via a RNC (radio network controller) and an Iu-UP (Iu-User Plane) is terminated at the RNC, including:
an IuUP negotiation result information acquiring device which requests the RNC to supply IuUP negotiation result information and receives the IuUP negotiation result information from the RNC; and
an interworking device which receives the IuUP negotiation result information from the IuUP negotiation result information acquiring device and executes protocol conversion between an IuUP protocol and a protocol used in the IMS by use of the IuUP negotiation result information when a connection is made between the CS terminal and the IMS.

According to an exemplary second aspect of the present invention, there is provided an interworking device which is placed between an IMS (IP Multimedia Subsystem) and a RNC terminating an Iu-UP (Iu-User Plane) and which is connected, via a network, with an IuUP negotiation result information acquiring device which acquires IuUP negotiation result information from the RNC, including:
an information management unit which receives the IuUP negotiation result information from the IuUP negotiation result information acquiring device; and
a protocol conversion unit which holds the IuUP negotiation result information acquired from the information management unit and executes protocol conversion between an IuUP protocol and a protocol used in the IMS by use of the IuUP negotiation result information.

According to an exemplary third aspect of the present invention, there is provided an IuUP negotiation result information acquiring device which is connected with an RNC and an interworking device placed between the RNC and an IMS (IP Multimedia Subsystem) and executing protocol conversion between an IuUP protocol and a protocol used in the IMS, including:
a control unit which requests the RNC to supply IuUP negotiation result information and receives the IuUP negotiation result information from the RNC; and
an information management unit which transmits the received IuUP negotiation result information to the interworking device.

According to an exemplary fourth aspect of the present invention, there is provided an Iu-UP protocol negotiation result information reporting method to be employed in a communication network system in which a CS (Circuit Switched) terminal is connected to an IMS (IP Multimedia Subsystem) via a RNC (radio network controller) and an Iu-UP (Iu-User Plane) is terminated at the RNC, wherein:
an IuUP negotiation result information acquiring device requests the RNC to supply IuUP negotiation result information and receives the IuUP negotiation result information from the RNC, and
an interworking device receives the IuUP negotiation result information from the IuUP negotiation result information acquiring device and executes protocol conversion between an IuUP protocol and a protocol used in the IMS by use of the IuUP negotiation result information when a connection is made between the CS terminal and the IMS.

According to an exemplary fifth aspect of the present invention, there is provided a protocol conversion method for an interworking device which is placed between an IMS (IP Multimedia Subsystem) and a RNC terminating an Iu-UP (Iu-User Plane) and which is connected, via a network, with an IuUP negotiation result information acquiring device which acquires IuUP negotiation result information from the RNC including the steps of:
receiving the IuUP negotiation result information from the IuUP negotiation result information acquiring device; and
executing protocol conversion between an IuUP protocol and a protocol used in the IMS by use of the received IuUP negotiation result information.

According to an exemplary sixth aspect of the present invention, there is provided an Iu-UP protocol negotiation result information reporting method to be employed by an IuUP negotiation result information acquiring device which is connected with an RNC and an interworking device placed between the RNC and an IMS (IP Multimedia Subsystem) and executing protocol conversion between an IuUP protocol and a protocol used in the IMS, comprising the steps of:
requesting the RNC to supply IuUP negotiation result information;
receiving the IuUP negotiation result information from the RNC; and
transmitting the received IuUP negotiation result information to the interworking device.

According to an exemplary seventh aspect of the present invention, there is provided a computer-readable information recording medium storing a program that causes a computer functioning as an interworking device, which is placed between an IMS (IP Multimedia Subsystem) and a RNC terminating an Iu-UP (Iu-User Plane) and which is connected, via a network, with an IuUP negotiation result information acquiring device which acquires IuUP negotiation result information from the RNC, to execute the steps of:
receiving the IuUP negotiation result information from the IuUP negotiation result information acquiring device; and
executing protocol conversion between an IuUP protocol and a protocol used in the IMS by use of the received IuUP negotiation result information.

According to an exemplary eighth aspect of the present invention, there is provided a computer-readable information recording medium storing a program that causes a computer functioning as an IuUP negotiation result information acquiring device, which is connected with an RNC and an interworking device placed between the RNC and an IMS (IP Multimedia Subsystem) and executing protocol conversion between an IuUP protocol and a protocol used in the IMS, to execute the steps of:
requesting the RNC to supply IuUP negotiation result information;
receiving the IuUP negotiation result information from the RNC; and
transmitting the received IuUP negotiation result information to the interworking device.

### Advantageous Effects of Invention

By the present invention, the IuUP negotiation result held by an RNC is reported to an IWF device in a system in which the Iu-UP (Iu-User Plane) is terminated at the RNC, by which IMS connection for a sound source connection (e.g., RBT) can be realized.

### BRIEF DESCRIPTION OF DRAWINGS

FIG. 1 A block diagram showing the configuration of a communication network system in accordance with an embodiment of the present invention.

FIG. 2 A sequence diagram showing the fundamental operation of the embodiment of the present invention.

FIG. 3 A schematic diagram showing an example of notation of SDP.

FIG. 4 A block diagram showing the configuration of a part of the communication network system in accordance with the embodiment of the present invention.

FIG. 5 A table showing the contents of a call information memory.

FIG. 6 A schematic diagram for explaining bearer protocol conversion between the Iu-UP protocol and the RFC3267 protocol which is executed by an IWF device.

FIG. 7 A block diagram showing an example of the composition of a computer.

### DESCRIPTION OF EMBODIMENTS

Referring now to the drawings, a description will be given in detail of a preferred embodiment in accordance with the present invention.

First, the configuration of the embodiment in accordance with the present invention will be described below.

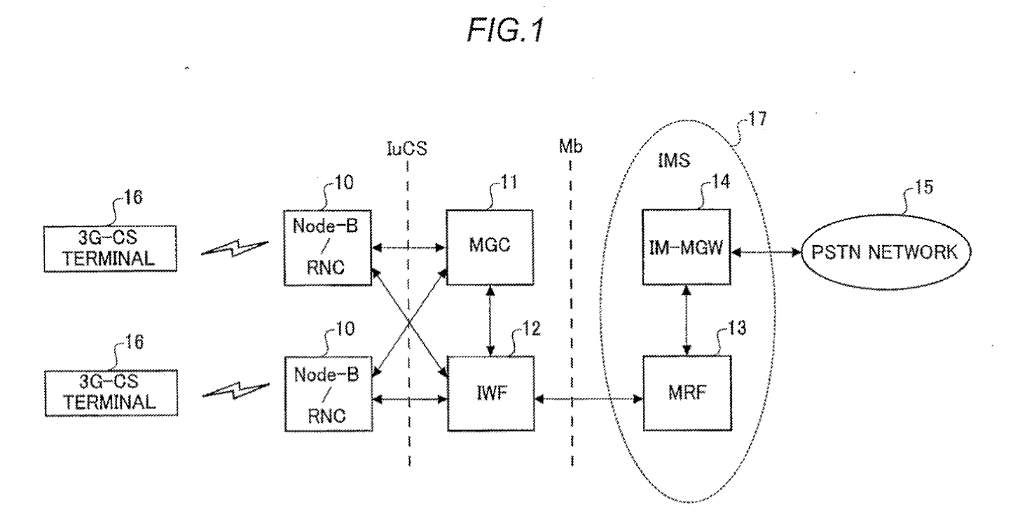

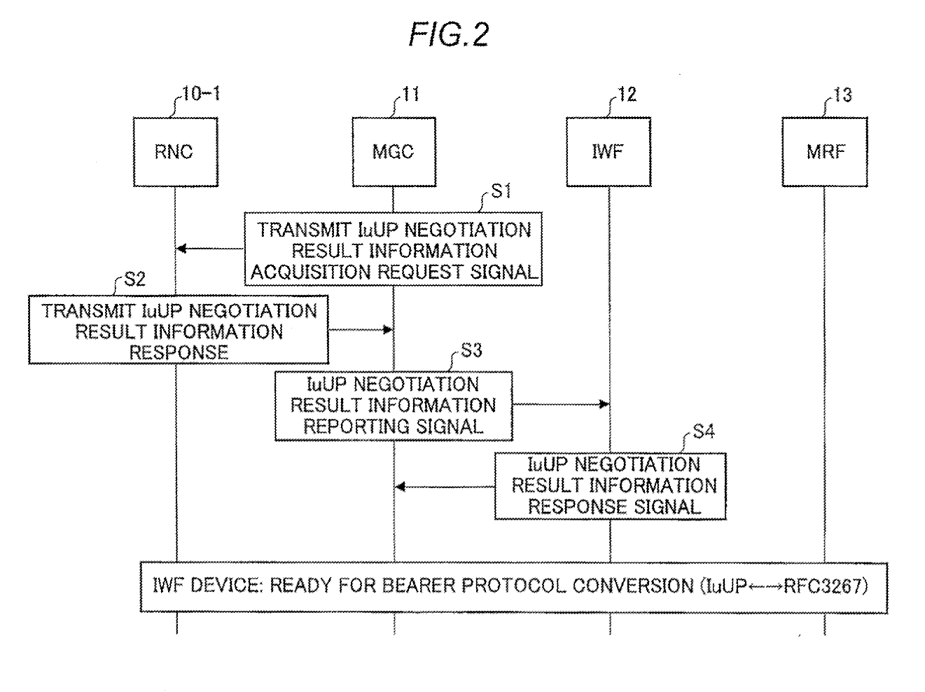

FIG. 1 is a block diagram showing the configuration of a communication network system in accordance with an embodiment of the present invention. FIG. 2 is a sequence diagram showing the fundamental operation of the communication network system of the embodiment.

As shown in FIG. 1, the communication network system of this embodiment includes Node-B/RNCs (Radio Network Controllers) 10, an MGC (Media Gateway Controller) 11 which functions as an IuUP negotiation result information acquiring device, an IWF (Inter Working Function) device 12 which functions as an interworking device, an MRF (Media Resource Function) device 13, and an IM-MGW (IP Multimedia subsystem Media Gateway) 14. A radio base station (indicated as “Node-B”) and an RNC are integrated into one device and indicated as “Node-B/RNC 10” in FIG. 1. Each Node-B/RNC 10 includes an RNC 10-1 as shown in FIG. 2.

Each Node-B/RNC 10 has been connected with a 3G-CS terminal 16, and the RNC 10-1 of the Node-B/RNC 10 holds IuUP negotiation result information. The MGC 11 executes communication of the IuUP negotiation result information with the RNCs 10-1. The MGC 11 also reports the Iu-UP negotiation result information to the IWF device 12.

Further, by use of the Iu-UP negotiation result information reported from the MGC 11, the IWF device 12 carries out the bearer protocol conversion between the IuUP protocol and the RFC3267 protocol when it connects with the MRF device 13. An IMS 17 includes the MRF device 13 and the IM-MGW 14. The IM-MGW 14 is connected with a PSTN network 15.

In a network system in which a CS terminal is connected to an IMS (i.e., IuCS is directly interworked to Mb) in order to receive a service provided, for example, and which is configured so that the RNCs serve as termination points of the Iu-UP, the IWF device is required to carry out the bearer protocol conversion between the IuUP protocol and the RFC3267 protocol in cases of MRF connection for streaming an RBT (Ring Back Tone). However, the IWF device does not have the Iu-UP negotiation result information since the RNCs are functioning as the Iu-UP termination points. For this reason, without any modification to the system, the bearer protocol conversion between the IuUP protocol and the RFC3267 protocol cannot be implemented by the IWF device.

In this embodiment, the Iu-UP negotiation result information is communicated between the RNC 10-1 and the MGC 11 and the MGC 11 reports the Iu-UP negotiation result information to the IWF device 12. This allows the IMF device to hold the Iu-UP negotiation result information and thereby carry out the bearer protocol conversion.

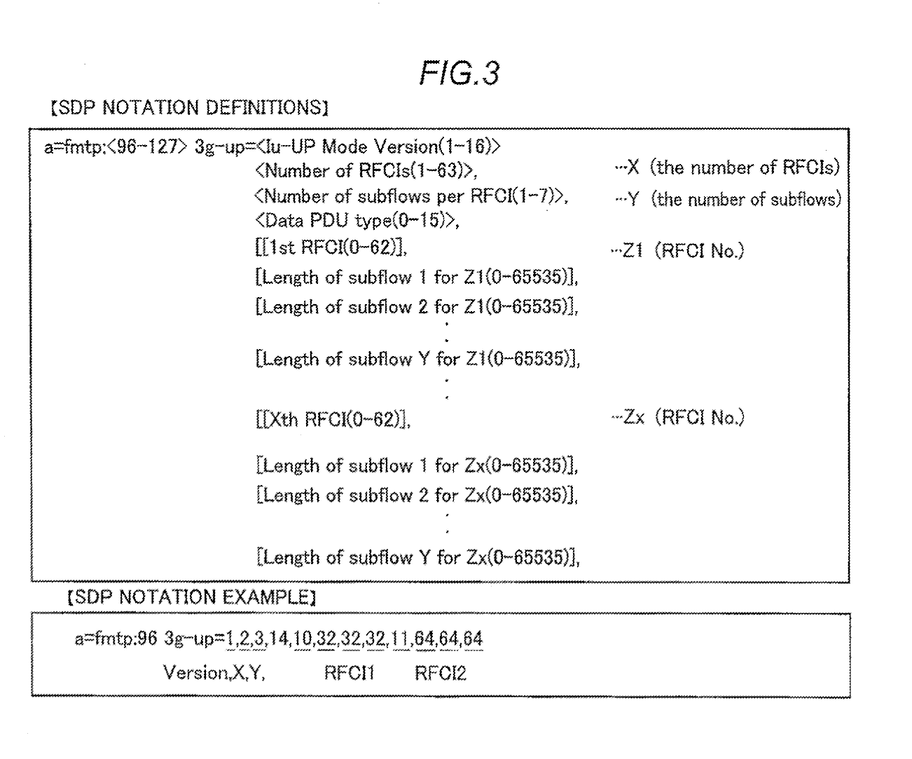

MEGACO (stipulated in 3GPP TS29.232) specifies no method for transferring the IuUP negotiation result information between the MGC 11 and the IWF device 12. Therefore, the IuUP negotiation result information is transferred between the MGC 11 and the IWF device 12 in this embodiment by adding new definitions to the SDP (Session Description Protocol) described in the MEGACO protocol. An example of the SDP is shown in FIG. 3.

Next, a procedure (characteristic operation of this embodiment) for reporting (noticing) the IuUP negotiation result information (terminated by an RNC 10-1) to the IWF device 12 finally needing the information will be explained with reference to FIG. 2.

As specified in 3GPP (3rd Generation Partnership Project) TS25.415, the RNC 10 terminates the IuUP and holds its negotiation result. The MGC 11 transmits an IuUP negotiation result information acquisition request signal to the RNC 10 (step S1). Upon receiving the IuUP negotiation result information acquisition request signal, the RNC 10 transmits an IuUP negotiation result information response signal to the MGC 11 so as to report the IuUP negotiation result information (currently held by the RNC 10) to the MGC 11 (step S2). Upon receiving the IuUP negotiation result information response signal, the MGC 11 transmits the received information to the IFW device 12 as an IuUP negotiation result information reporting (notification) signal (step S3). The IWF device 12 receiving the IuUP negotiation result information reporting signal returns an IuUP negotiation result information response signal to the MGC 11 (step S4).

For the IuUP negotiation result information reporting signal in the above step S3, MEGACO (general-purpose protocol stipulated in 3GPP TS29.232) is used. As mentioned above, the IuUP negotiation result information is transferred between the MGC 11 and the IWF device 12 in this embodiment by adding new definitions to the SDP described in the MEGACO protocol.

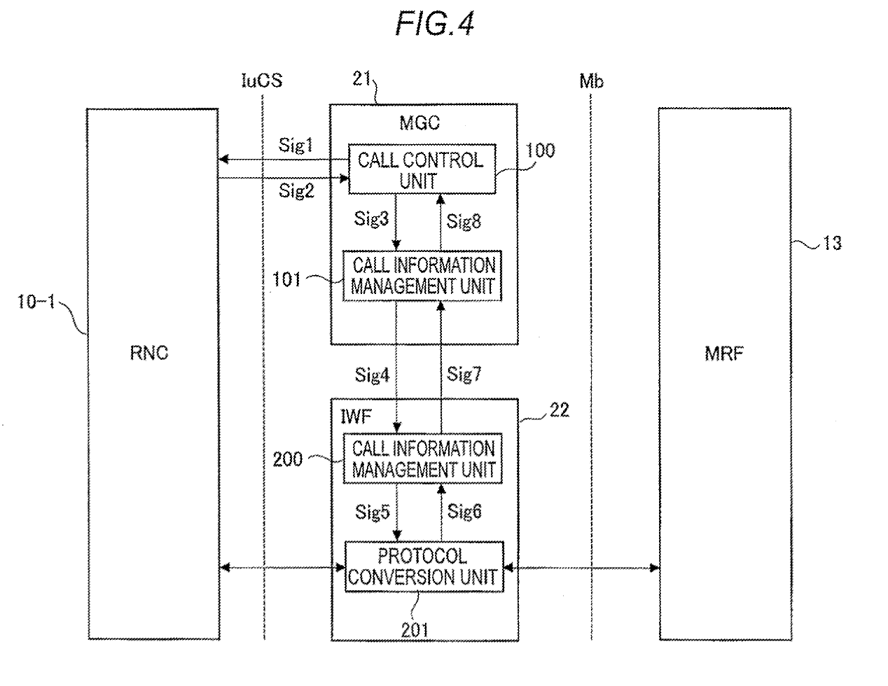

In the following, the method of reporting the Iu-UP protocol negotiation result information will be described in more detail with reference to FIGS. 4 to 6.

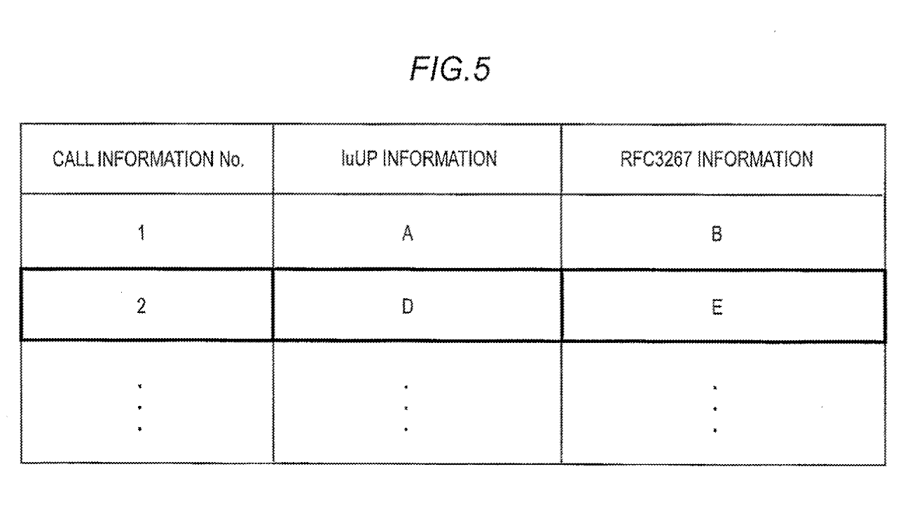

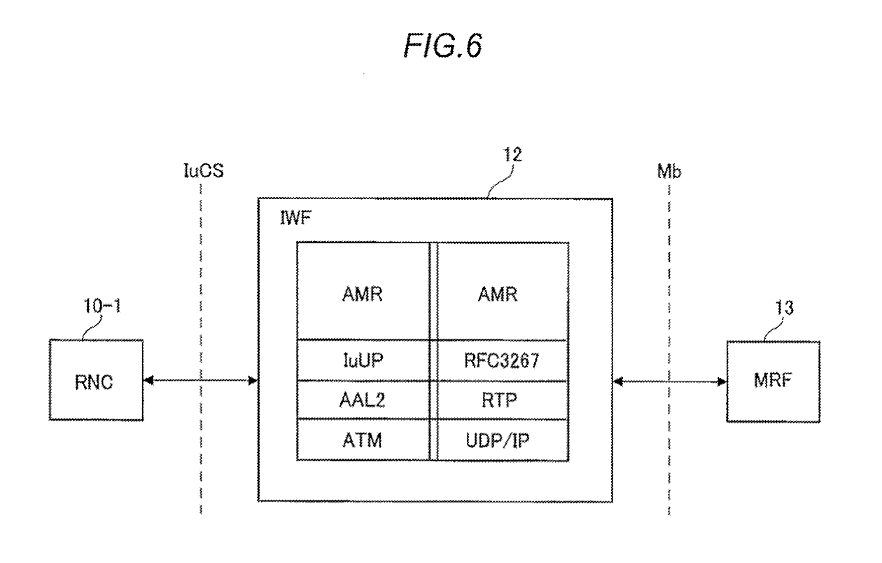

As shown in FIG. 4, a call control unit 100 of the MGC 21 transmits the IuUP negotiation result information acquisition request signal Sig1 to the RNC 10. The RNC 10 receiving the IuUP negotiation result information acquisition request signal Sig1 returns the IuUP negotiation result information response signal Sig2 to the call control unit 100 as the response to the acquisition request signal Sig1. The response signal Sig2 includes the IuUP negotiation result information which has been terminated and held by the RNC 10. The call control unit 100 of the MGC 21 receiving the IuUP negotiation result information response signal Sig2 sends a setting signal Sig3 to a call information management unit 101 so as to report and set the IuUP negotiation result information to the call information management unit 101. The call information management unit 101 receiving the setting signal Sig3 adds the IuUP negotiation result information to the SDP information in the MEGACO protocol and then transmits the obtained MEGACO signal to a call information management unit 200 of the IWF 22 as a signal Sig4. The call information management unit 200 of the IWF 22 receiving the signal Sig4 sets the IuUP negotiation result information to a protocol conversion unit 201 of the IWF 22. Thereafter, a response signal (Sig6, Sig7, Sig8) is returned to the call control unit 100 of the MGC 21 as the response to the setting signal Sig3 transmitted by the call control unit 100. By this process, the correspondence between the IuUP negotiation result information and RFC3267 information has been set in a call information memory of the protocol conversion unit 201 as shown in FIG. 5, by which the protocol conversion between the IuUP protocol and the RFC3267 protocol is made possible. For example, in the case of the call information number 2 stored in the call information memory shown in FIG. 5, it is possible to convert from IuUP information D to RFC3267 information E and similarly, to convert from the RFC3267 information E to the IuUP information D. By the above process, the protocol conversion shown in FIG. 6 is made possible.

By the process described above, the reporting of the IuUP negotiation result information terminated by the RNC to the IWF device 12 (which has to carry out the bearer protocol conversion between the IuUP protocol and the RFC3267 protocol in cases of connection to the MRF device 13) becomes possible.

In this embodiment of the present invention, the following effects are achieved by the above operation.

The reporting of the IuUP negotiation result information held by the RNC to the IWF device is realized by this embodiment as explained above. Therefore, also when a connection is made to the MRF for a sound source connection (e.g., RBT), the IWF device is allowed to carry out the bearer protocol conversion between the Iu-UP protocol and the RFC3267 protocol, by which the provision of a sound source service (e.g., RBT) is made possible.

Incidentally, each of devices (RNC 10, MGC 11, IWF device 12, and MRF device 13) employed in this embodiment can be implemented by hardware. However, it is also possible to make a computer load a program (instructing the computer to function as each of devices (RNC 10, MGC 11, IWF device 12, and MRF device 13)) from an information recording medium and execute the program.

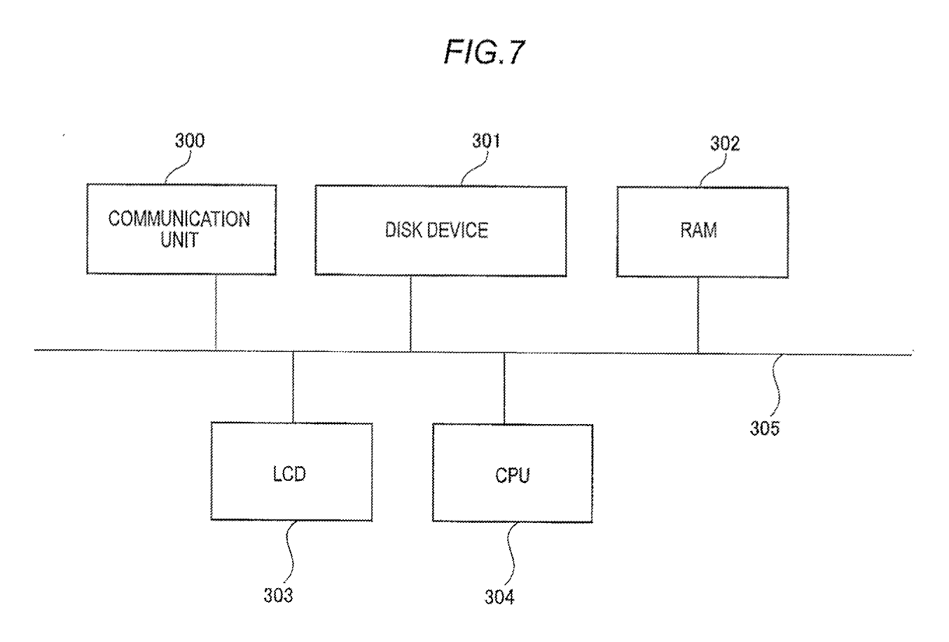

FIG. 7 is a block diagram showing an example of the composition of the computer. A program describing the operation of the MGC 11 or the IWF device 12 shown in FIGS. 2 and 4 is stored in a disk device 301 such as a hard disk drive or a storage device such as a ROM (the disk device is shown in this example), and the IuUP negotiation result information is stored in the disk device 301 or in a RAM 302 (e.g., DRAM) which is used as a memory. The program for implementing the MGC 11 or IWF device 12 is executed by a CPU 304. An LCD 303 as a display device displays information processing status of the MGC 11 or IWF device 12. The reference numeral “305” represents a bus (e.g., data bus) and “302” represents the RAM for storing information necessary for the information processing by the CPU 304. The IuUP negotiation result information is inputted to and outputted from the computer via a communication unit 300 and stored in the RAM 302 serving as the call information memory. The aforementioned program is supplied to the computer through a computer-readable information recording medium (flexible disk (e.g., FD (Floppy Disk)), CD-ROM, DVD, flash memory, etc.) storing the program or through a network such as the Internet. By making the computer load and execute the program, the MGC 11 or the IWF device 12 can be implemented.

While an exemplary embodiment of the present invention has been described above, it is to be understood that the present invention can be implemented in various other forms without departing from the spirit or principal features of the present invention specified by the appended claims. Therefore, the embodiment described above is just for illustration and should not be interpreted in a restrictive manner. The scope of the present invention is specified by the appended claims and not restricted by the description in the specification or the abstract. Further, modifications, alterations, etc. belonging to scope equivalent to that of the claims are all within the scope of the present invention.

This application claims priority based on Japanese Patent Application No. 2008-184870 filed Jul. 16, 2008, which is hereby incorporated by reference in its entirety.

### REFERENCE SIGNS LIST

10 RNC
11 MGC
12 IWF device
13 MRF
14 IM-MGW
15 PSTN network
16 3G-CS terminal
17 IMS

1. A communication network system in which a Circuit Switched (CS) terminal is connected to an IP Multimedia Subsystem (IMS) via a radio network controller (RNC) and an Iu-User Plane (Iu-UP) is terminated at the RNC, comprising:
an IuUP negotiation result information acquiring device which requests the RNC to supply IuUP negotiation result information and receives the IuUP negotiation result information from the RNC; and
an interworking device which receives the IuUP negotiation result information from the IuUP negotiation result information acquiring device and executes protocol conversion between an IuUP protocol and a protocol used in the IMS by use of the IuUP negotiation result information when a connection is made between the CS terminal and the IMS.

2. The communication network system according to claim 1, wherein:
Media Gateway Controller (MEGACO) protocol is employed for the communication of the IuUP negotiation result information between the interworking device and the IuUP negotiation result information acquiring device, and
the transmission/reception of the IuUP negotiation result information between the interworking device and the IuUP negotiation result information acquiring device is executed by adding new definitions to a Session Description Protocol (SDP) described in the MEGACO protocol.

3. The communication network system according to claim 1, wherein the protocol conversion executed by the interworking device is bearer protocol conversion between the IuUP protocol and a protocol in conformity with RFC3267.

4. An interworking device which is placed between an IP Multimedia Subsystem (IMS) and a RNC terminating an Iu-User Plane (Iu-UP) and which is connected, via a network, with an IuUP negotiation result information acquiring device which acquires IuUP negotiation result information from the RNC, comprising:
an information management unit which receives the IuUP negotiation result information from the IuUP negotiation result information acquiring device; and
a protocol conversion unit which holds the IuUP negotiation result information acquired from the information management unit and executes protocol conversion between an IuUP protocol and a protocol used in the IMS by use of the IuUP negotiation result information.

5. The interworking device according to claim 4, wherein the protocol conversion is bearer protocol conversion between the IuUP protocol and a protocol in conformity with RFC3267.

6. An IuUP negotiation result information acquiring device which is connected with an RNC and an interworking device placed between the RNC and an IP Multimedia Subsystem (IMS) and executing protocol conversion between an IuUP protocol and a protocol used in the IMS, comprising:
a control unit which requests the RNC to supply IuUP negotiation result information and receives the IuUP negotiation result information from the RNC; and
an information management unit which transmits the received IuUP negotiation result information to the interworking device.

7. The IuUP negotiation result information acquiring device according to claim 6, wherein:
a MEGACO protocol is employed for the communication with the interworking device, and
the transmission of the IuUP negotiation result information to the interworking device is executed by adding new definitions to an SDP described in the MEGACO protocol.

8-18. (canceled)
